(19) United States
(12) Patent Application Publication
(10) Pub. No.: US 2006/0213315 A1
(43) Pub. Date: Sep. 28, 2006

(54) Vehicle steering device with a stationary central part

(75) Inventor: Stefan Faeth, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/372,543

(22) Filed: Mar. 10, 2006

(30) Foreign Application Priority Data
Mar. 10, 2005 (DE) 20 2005 003 848.2

(51) Int. Cl. B62D 1/04

(52) U.S. Cl. 74/552

(57) ABSTRACT

A vehicle steering device (10) includes a steering wheel part which is non-rotatably coupled to a steering column (18) and a central part which is stationary with respect to a rotation of the steering wheel part. The vehicle steering device (10) further includes a gear unit (24) which converts a rotation of the steering wheel part in a first direction into a corresponding rotation of the central part in a second direction opposed to the first direction. The vehicle steering device (10) further includes a helically coiled spring (30) which carries leads for the electrical connection of functional units which are arranged on the central part.

### TECHNICAL FIELD

The invention relates to a vehicle steering device comprising a steering wheel part which is non-rotatably coupled to a steering column, and a central part which is stationary with respect to a rotation of the steering wheel part.

### BACKGROUND OF THE INVENTION

Steering devices having a stationary central part basically have the advantage that operating elements which are arranged on the central part are always found at the same location, irrespective of the position of the steering wheel. In steering devices having a gas bag module which is housed in the stationary central part, the gas bag no longer necessarily has to be arranged symmetrically to the centre of rotation of the steering device. As the orientation of the gas bag, which unfolds from the stationary central part, is established from the outset, asymmetrical gas bag shapes having optimized restraining characteristics can be used. However, both the mechanical realization of the assemblies which are rotatable relative to each other, and also the wiring of the components which are arranged on the stationary central part, prove to be difficult.

A solution is known from DE 36 21 226 C1 which makes possible a relative rotation between the steering wheel part and the central part, the mechanical stresses being transferred via a special, fixed gear. The connection of a gas bag module which is integrated into the central part takes place via a fixed cable shaft.

A similar solution, but having a gear which is coupled to the rotatable steering wheel part, is shown in German Utility Model DE 20 2004 007 617 U1. The steering wheel device shown therein comprises a steering wheel part which is non-rotatably coupled to a steering column, and a central part which is stationary with respect to a rotation of the steering wheel part. The device further comprises a gear unit which converts a rotation of the steering wheel part in a first direction into a corresponding rotation of the central part in a second direction opposed to the first direction. It is proposed to uncouple the gas generator mechanically from the gas bag module, such that the latter is co-rotated with the rotatable steering wheel part in order to thus make possible a wiring with a normal wound spring as in conventional steering wheels without a stationary central part. Alternatively, a wiring for a stationary gas generator is provided with the aid of a main clock spring and an additional secondary clock spring.

EP 1 323 617 B1 proposes a steering device having a central part which can be rotated both with respect to the rotatable steering wheel part and also with respect to the fixed steering column assembly with the aid of an electric motor. The power transmission takes place here via a helically coiled spring, the spokes of the rotatable steering wheel part engaging between two coils of the spring. However, it has been found that the requirements for torsional rigidity of the spring can not be readily fulfilled.

It is an object of the invention to provide a steering device with a stationary central part which offers a reliable relative rotation between the steering wheel part and the central part and also a favourably priced wiring option for the electrical functional units which are arranged on the stationary central part.

### BRIEF SUMMARY OF THE INVENTION

According to the invention, a vehicle steering device comprises a steering wheel part which is non-rotatably coupled to a steering column; a central part which is stationary with respect to a rotation of the steering wheel part; a gear unit which converts a rotation of the steering wheel part into a corresponding rotation of the central part in a second direction opposed to the first direction; and a helically coiled spring which carries leads for the electrical connection of functional units which are arranged on the central part. The basis of the invention is the clear separation between the transmission of rotation and the electrical connection. The gear unit, which permits a sturdy transmission of the mechanical forces and only requires a small amount of structural space, is responsible on its own for the transmission of the rotation of the steering wheel part to the central part in the opposite direction. Independently thereof, the electrical connection of the functional units of the central part, in particular of a gas bag module, takes place with the aid of the helically coiled spring. Therefore, a clock spring is no longer necessary at all. As the spring does not have to transfer any mechanical forces, no particular requirements exist with regard to its torsional rigidity.

According to a preferred embodiment of the invention, the steering wheel part comprises a hub of the vehicle steering device having a passage opening through which the spring is passed.

### BRIEF DESCRIPTION OF THE DRAWINGS

FIG. 1 shows a vehicle steering device according to the invention, in perspective view;

FIG. 2 shows the part of the steering device according to the invention which is responsible for the relative rotation, in perspective view;

FIG. 3 shows a helical spring for the electrical connection, in perspective view;

FIG. 4 shows a hub of the steering device according to the invention, in perspective view; and

FIG. 5 shows a diagrammatic sectional view through a part of the steering device according to the invention.

### DETAILED DESCRIPTION OF THE PREFERRED EMBODIMENT

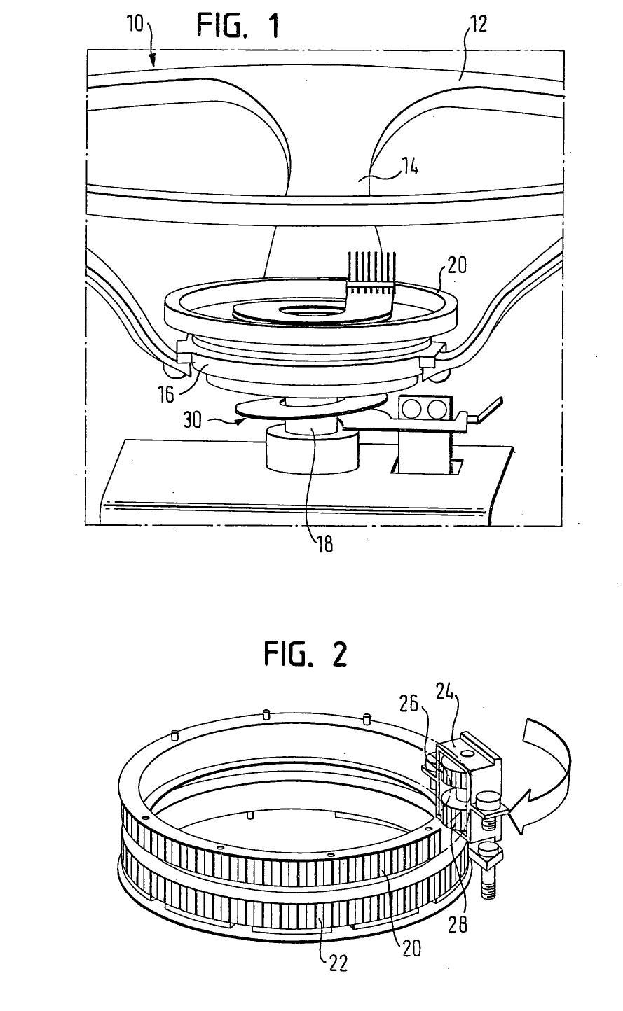

In FIG. 1 a vehicle steering device 10 is shown, having a steering wheel rim 12, spokes 14 and a hub 16 which is connected non-rotatably to a steering column 18. The entirety of the components which are coupled non-rotatably to the steering column 18 is designated below as “the steering wheel part”. The steering device 10 has in addition a central part which is stationary with respect to the rotatable steering wheel part. Only an upper toothed rim 20 of the stationary central part is shown in FIG. 1. Functional units, in particular a gas bag module, horn switch, operating keys etc., are arranged on the central part. So that the central part maintains its stationary position independently of a rotation of the steering wheel part, a relative rotation is necessary between these two assemblies. The relative rotation is made possible by a special gear unit 24 having a double pinion part (see FIG. 2). Such a gear unit is known per se from German Utility Model DE 20 2004 007 617 U1, which is incorporated herein by reference.

The double pinion part is mounted in a skeleton section of the steering device 10 which is connected with the hub 16, more precisely in a base section of the skeleton. The upper pinion 26 and the lower pinion 28 of the double pinion part are in engagement with two identical encircling toothed rims 20 and 22 respectively. The lower toothed rim 22 is mounted to a fixed part of the vehicle. The upper toothed rim 20, which has already been mentioned, is a component of the stationary central part.

The double pinion part is entrained upon a rotary movement of the steering wheel part. As the lower toothed rim 22 is mounted to a fixed part of the vehicle, the lower pinion 28 runs on the lower toothed rim 22. The rotation of the lower pinion 28 is transferred to the upper pinion 26. Thereby, the upper toothed rim 20 and hence the entire central part of the steering device 10 is rotated with identical speed in opposition to the direction of rotation of the steering wheel part. Therefore, the central part remains in its initial position and does not co-rotate with the steering wheel part.

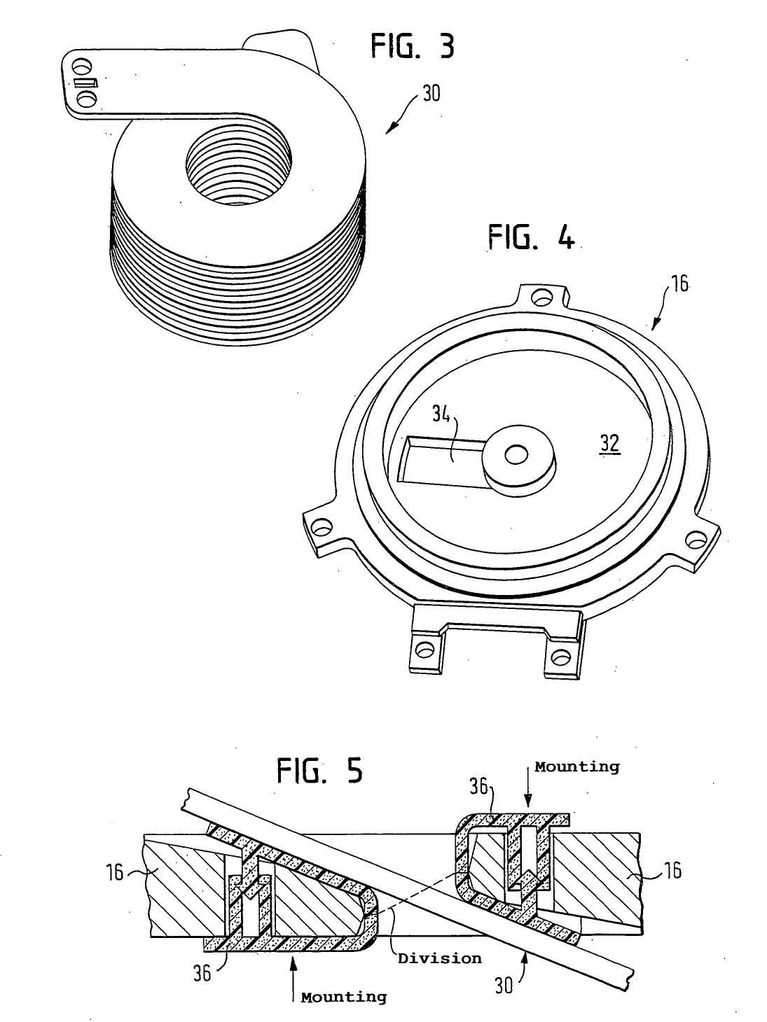

A helically coiled spring 30, which is shown in detail in FIG. 3, is arranged coaxially to the steering column 18. The spring 30 serves as a carrier for the leads which are necessary for the electrical connection of the functional units arranged on the central part. The spring 30, which is elastic in axial direction, has several coils of the same diameter, which have a generally rectangular cross-section.

The upper end of the spring 30 is connected with the stationary central part of the steering device 10. The lower end of the spring 30 is mounted to a fixed part of the vehicle. As can be seen in FIG. 4, the base 32 of the hub 16 has a passage openinsg 34 through which the spring 30 is passed. The base 32 of the hub 16 therefore engages between two coils of the spring 30. Upon a rotation of the steering wheel part, the section of the spring 30 between the hub base 32 and the central part is either compressed axially or drawn apart, depending on the direction of rotation. The reverse applies respectively for the section of the spring 30 between the hub base 32 and the steering arm.

As shown in FIG. 5, one or more plastic clips 36, in particular Teflon clips, can be inserted between the spring 30 and the hub 16 or respectively the spokes 14 of the steering device 10, in order to reduce the friction between these components.

1. A vehicle steering device, comprising
a steering wheel part which is non-rotatably coupled to a steering column,
a central part which is stationary with respect to a rotation of the steering wheel part,
a gear unit which converts a rotation of the steering wheel part in a first direction into a corresponding rotation of the central part in a second direction opposed to the first direction, and
a helically coiled spring which carries leads for the electrical connection of functional units which are arranged on the central part.

2. The vehicle steering device according to claim 1, wherein the spring is arranged coaxially to the steering column and is elastic in axial direction.

3. The vehicle steering device according to claim 1, wherein one end of the spring is connected with the central part and the other end of the spring is mounted to a fixed vehicle part.

4. The vehicle steering device according to claim 1, wherein the steering wheel part comprises a hub with a passage opening through which the spring is passed.

5. The vehicle steering device according to claim 1, wherein at least one plastic clip is provided to reduce the friction between the spring and the rotatable steering wheel part.

6. The vehicle steering device according to claim 1, wherein the gear unit includes two pinions which are coupled non-rotatably to each other, one of the pinions being in engagement with a first toothed rim coupled to the central part, and the other pinion being in engagement with a second toothed rim which is mounted to a fixed vehicle part.
